(19) United States
(12) Patent Application Publication
(10) Pub. No.: US 2024/0288684 A1
(43) Pub. Date: Aug. 29, 2024

(54) EFFICIENT AND COMPACT BEAM EXPANDER FOR VR/AR HEADSETS

(71) Applicant: Meta Platforms Technologies, LLC, Menlo Park, CA (US)

(72) Inventors: Wai Sze Tiffany Lam, Lynnwood, WA (US); Wanli Chi, Sammamish, WA (US); Jian Xu, Redmond, WA (US)

(21) Appl. No.: 18/587,339

(22) Filed: Feb. 26, 2024

Related U.S. Application Data
(60) Provisional application No. 63/448,475, filed on Feb. 27, 2023.

(51) Int. Cl. G02B 26/10; G02B 5/18; G02B 27/01; G02B 27/09; G02B 27/44; G06T 19/00

(52) U.S. Cl. CPC G02B 26/106; G02B 5/18; G02B 27/0172; G02B 27/0944; G02B 27/44; G06T 19/006

(57) ABSTRACT

An apparatus of the subject technology includes a light source to generate a light beam, a first grating illuminated by the light beam, and a second grating optically coupled to the first grating. The first grating performs a first diffraction to expand the light beam in a first dimension to form a first beam. The second grating performs a second diffraction to expand the first beam in a second dimension to provide a backlight for a display device.

### CROSS-REFERENCE TO RELATED APPLICATIONS

The present disclosure is related and claims priority under 35 USC § 119(e) to U.S. Provisional Application No. 63/448,475, entitled “EFFICIENT AND COMPACT BEAM EXPANDER FOR VR/AR HEADSETS,” filed on Feb. 27, 2023, the contents of which are herein incorporated by reference, in their entirety, for all purposes.

### BACKGROUND

### Technical Field

The present disclosure is related to display devices of virtual reality (VR) and/or augmented reality (AR) headsets. More specifically, the present disclosure is directed to efficient and compact devices that expand an illuminating beam in two dimensions for illuminating a pixelated display device in a VR/AR headset.

### Related Art

Two-dimensional display devices, for example, liquid crystal displays (LCDs) are illuminated in the backend by collimated light sources such as white light-emitting diode (LED) or a coherent source such as a red-green-blue (RGB) laser that desirably illuminate the entire area of the backend of the display device. These backlights can impose design constraints, for instance, restrictions related to the display size. Additionally, multilayered display devices for VR/AR applications typically have low transmission efficiency, which exacerbates the power usage of the display device, in detriment of battery lifetime, which is critical for headset applications.

### SUMMARY

An aspect of the subject technology is directed to an apparatus that includes a light source to generate a light beam, a first grating illuminated by the light beam, and a second grating optically coupled to the first grating. The first grating performs a first diffraction to expand the light beam in a first dimension to form a first beam. The second grating performs a second diffraction to expand the first beam in a second dimension to provide a backlight for a display device.

Another aspect of the disclosure is related to a beam expander system including a laser to generate a first beam, a first Bragg grating illuminated by the first beam, a polarizing component and a second Bragg grating optically coupled to the first Bragg grating. The first Bragg grating creates a first diffracted beam in a first dimension, and the polarizing component changes a polarization state of the first diffracted beam. The second Bragg grating creates a second diffracted beam to expand the first polarized diffracted beam in a second dimension to provide a backlight for a display device.

Yet another aspect of the disclosure is related to a beam expander system that includes a first volume Bragg grating (VBG) illuminated by a first collimated beam to form a first diffracted beam along a length of the first VBG and a polarizing component configured to switch polarization state of the first diffracted beam. The beam expander system further includes a second VBG to expand the first polarized diffracted beam to form a backlight for a display device.

### BRIEF DESCRIPTION OF THE DRAWINGS

To easily identify the discussion of any particular element or act, the most significant digit or digits in a reference number refer to the figure number in which that element is first introduced.

FIGS. 1A and 1B are schematic diagrams illustrating examples of a compact beam expander, according to certain aspects of the subject technology.

FIGS. 1C and 1D are schematic diagrams illustrating an existing LCD with a laser backlight.

FIGS. 2A and 2B are schematic diagrams illustrating an example of an LCD with improved throughput along with a corresponding display device with fill-factor limitation, according to certain aspects of the subject technology.

FIGS. 2C, 2D, 2E and 2F are schematic diagrams illustrating an example of beam expander with improved throughput along with images of corresponding beams, according to certain aspects of the subject technology.

FIGS. 3A and 3B are schematic diagrams illustrating an example of a compact liquid crystal on silicon (LCOS) display device along with a corresponding display with improved fill-factor, according to certain aspects of the subject technology.

FIG. 3C is a schematic diagram illustrating an example of an existing LCOS display system.

FIG. 4 is a schematic diagram illustrating an example of a monolithic dual VBG illuminator with a waveplate, according to certain aspects of the subject technology.

FIG. 5 is a schematic diagram illustrating the example monolithic dual VBG illuminator of FIG. 4 with an optional prism, according to certain aspects of the subject technology.

FIGS. 6A and 6B are schematic diagrams illustrating an example of a monolithic dual VBG illuminator with a half-wave film and a cross sectional view of the half-wave film, according to certain aspects of the subject technology.

FIG. 7A is a schematic diagram illustrating an example of a monolithic dual VBG illuminator with a polarizing component, according to certain aspects of the subject technology.

FIG. 7B is a schematic diagram illustrating an example of a monolithic dual VBG illuminator with an angled surface VBG1, according to certain aspects of the subject technology.

FIGS. 8A and 8B are schematic diagrams illustrating examples of backlight system with a collimated beam and a corresponding image including artifacts.

FIGS. 9A and 9B are schematic diagrams illustrating examples of compact beam expander with illumination steering and a corresponding backlight system, according to certain aspects of the subject technology.

FIGS. 10A and 10B are schematic diagrams illustrating examples of compact beam expander and a multiplexer (MUX) pitch VBG, according to certain aspects of the subject technology.

FIG. 10C is a schematic diagram illustrating examples of steps in forming a MUX pitch VBG, according to certain aspects of the subject technology.

FIGS. 11A, 11B and 11C are schematic diagrams illustrating examples of a compact beam expander with zonal illumination and corresponding images of a small beam and an expanded beam, according to certain aspects of the subject technology.

In the figures, elements having the same or similar reference numerals are associated with the same or similar attributes, unless explicitly stated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure. Embodiments as disclosed herein will be described with the description of the attached figures.

Example architectures of the subject technology is directed to an apparatus that includes a light source to generate a light beam and a first grating illuminated by the light beam, and a second grating optically coupled to the first grating. The first grating is used to perform a first diffraction that can expand the light beam in a first dimension and form a first beam. The second grating is used to perform a second diffraction to expand the first beam in a second dimension and provide a backlight for a display device (e.g., an LCD or LCOS).

In some implementations, the first grating is illuminated by a collimated light beam of a laser source.

In one or more implementations, the first diffraction is a first single diffraction that creates a first single-diffracted beam that can expand the light beam in the first dimension of the first grating coupled to the second grating.

In some implementations, the second diffraction is a second single diffraction that creates a second single-diffracted beam that expands the expanded first beam in the second dimension to form a two-dimensional beam perpendicular to a plane of the second grating.

In one or more implementations, the first grating is a first Bragg grating such as a first VBG, and the second grating is a second Bragg grating such as a second VBG.

In some implementations, the first VBG and the second VBG are single-diffraction VBGs.

In one or more implementations, at least one of the first VBG and the second VBG is a multiplexed (MUX) VBG including multiple gratings with different pitches used to generate a MUX diffracted beam to increase a diffracted angle range.

In one or more implementations, the display device comprises an LCD or an LCOS display device.

In some implementations, the apparatus of the subject technology further includes a polarizing component between the first grating and the second grating.

In one or more implementations, the polarizing component comprises a half-wave plate used to change a polarization state of the first beam.

In some implementations, the apparatus of the subject technology further includes a reflector plate that is used to steer the light beam at various angles to increase a pupil size of the backlight.

In one or more implementations, the light source is a grid of lasers, and each laser of the grid is selectively controllable to be switched on or off to form a zonal beam pattern that can convert the backlight to a zonal backlight with a zonal pattern.

The display device of the subject technology can advantageously be used in various applications including AR and VR devices to make these devices more compact. Further, the application of the subject technology can improve image uniformity and diffraction efficiency and mitigate some artifact issues, for example, due to particles in the rays of the illumination beam and scratches in optics. Some implementations of the subject technology can allow zonal illumination, which results in power saving and improved contrast, as further described herein.

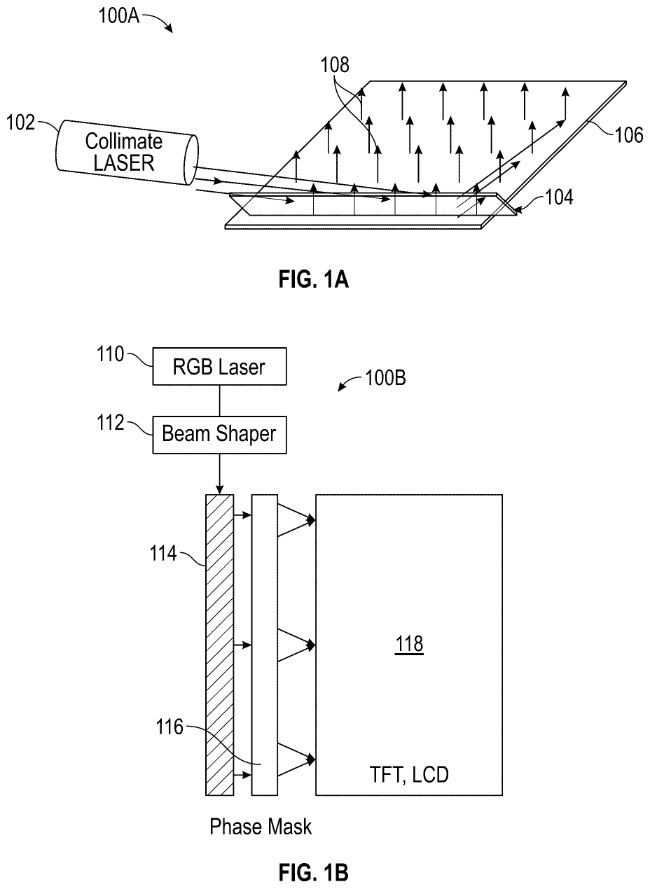

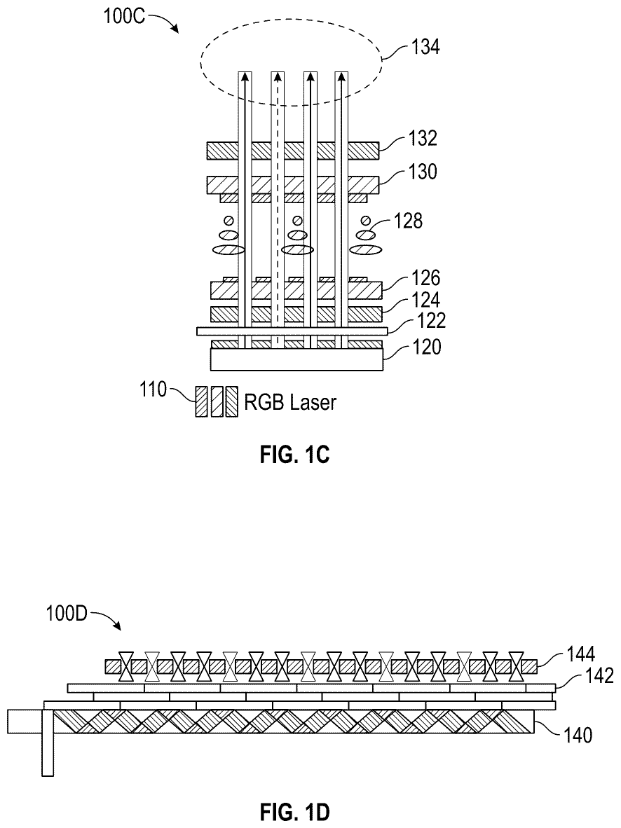

Now turning to the description of figures, FIGS. 1A and 1B are schematic diagrams illustrating examples of compact beam expander systems 100A and 100B, according to certain aspects of the subject technology. The compact beam expander system 100A provides a wide illumination beam for a pixelated display device such as an LCD or an LCOS in an AR and/or VR headset. The compact beam expander system 100A includes a light source 102, a first VBG 104 and a second VBG 106. The light source 102 provides an input backlight illumination for the display device. In one or more implementations, the light source 102 may include a laser (e.g., a laser diode) in one or more visible colors (e.g., RGB), or a broadened source, such as a light emitting diode (LED) and/or other light sources. In some implementations, a collimating element can be used to form the input illumination into a collimated beam directed to the first VBG 104. The first VBG 104 receives the collimated beam input with a first polarization, and to provide a first expanded beam, using a single diffraction, in a first direction into the second VBG 106. The second VBG 106 receives the first expanded beam in the first direction and provides, using another single diffraction, a second expanded beam 108 with a second polarization in a second direction to a display device, for example, an AR and/or VR headset. In some implementations, the second polarization is the same as the first polarization.

The compact beam expander system 100B includes a light source 110 (e.g., an RGB laser), a beam shaper 112, a VBG beam expander 114, a phase mask 116, and a display device 118. The beam shaper 112 can be a collimating element that receives, in a first surface, a collimated gaussian beam, for example, as provided by a graded index (GRIN) lens placed in front of an LED or a laser diode. The output surface of the collimating element is shaped such as to provide a collimated beam with a uniform intensity profile over a cross-section (e.g., a top-hat profile). Such a collimated beam can produce a uniform intensity in the display of the VR/AR headset, as desirable.

The phase mask 116 is a phase-shift mask that is an optical element that can encode the entire spectral response of the VBG beam expander 114 including the Bragg wavelength and the type of spectral response. The display device 118 can be an LCD display or an LCD-thin film transistor (TFT) display. The TFTs are active elements (e.g., transistors) made of a semiconductor (e.g., silicon) that act as switches for each pixel of the LCD display, turning them on or off. The addition of TFT in the LCD displays has vastly improved the use of LCDs in various display applications.

FIGS. 1C and 1D are schematic diagrams illustrating an existing LCD structure 100C and a phase plate structure 100D. The LCD structure 100C consists of a number of layers including 110, a grating light guide or waveguide 120, a phase plate 122 (or a microlens array), a first polarizer 124, a TFT 126, an LC 128, a color filter 130 and a second polarizer 132. The LCD structure 100C generates an RGB light beam 134 when illuminated by the light source 110 that can be an RGB laser source. Each of the layers of the LCD 100C has a specific throughput and result in an overall throughput of about 70%.

This overall throughput is smaller than the throughput of about 95% of the compact beam expander system 100B of the subject technology. Furthermore, the compact beam expander system 100B, other than being a monolithic structure that is more compact and enabling a higher throughput than the existing LCD structure 100C, has other advantageous features. For example, the compact beam expander system of the subject technology can mitigate fringe speckles, improve angular spread of a compact LCOS solution and allow for a zonal illumination with a compact VBG illumination, resulting in power saving.

The phase plate structure 100D shows a more detailed structure of the phase plate 122 of the LCD structure 100C and includes a waveguide 140, a microlens array 142 and an LC pane with TFT 144.

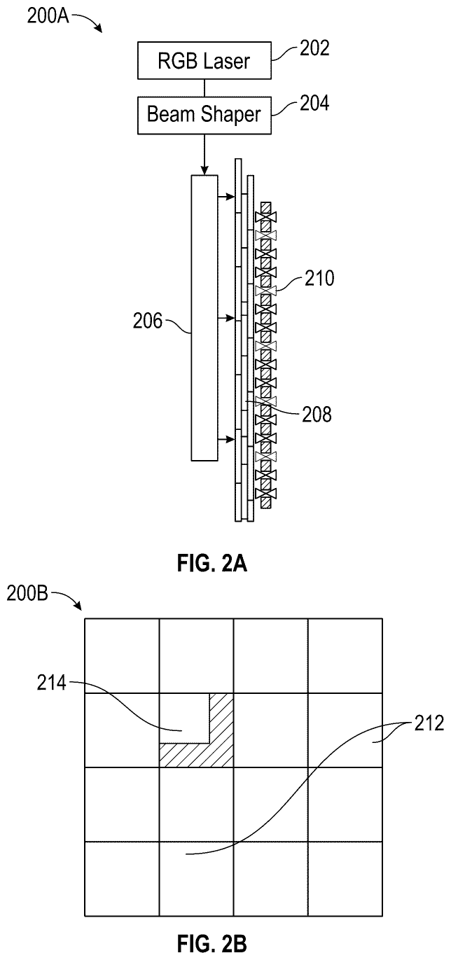

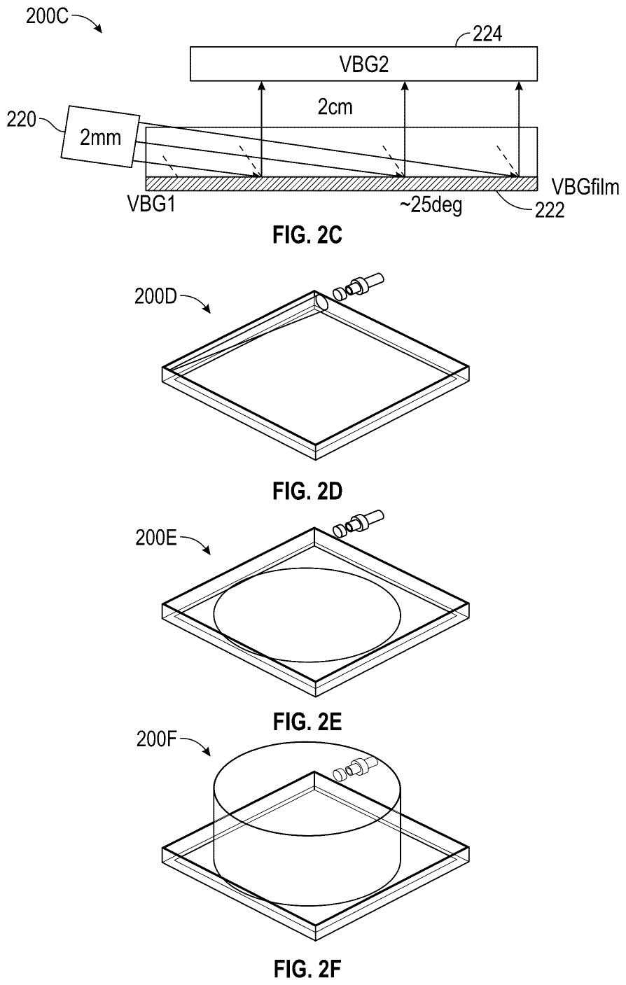

FIGS. 2A and 2B are schematic diagrams illustrating an example of an LCD 200A with improved throughput along with a corresponding display 200B with fill-factor limitation, according to certain aspects of the subject technology. The LCD 200A of the subject technology includes a light source 202, a beam shaper 204, a VBG compact beam expander 206 (hereinafter, beam expander 206), a phase mask 208 and a display panel 210. In light source 202 can be an RGB laser or other light sources. The beam shaper 204 can be collimator as described above with the beam shaper 112 of FIG. 1B. The VBG compact beam expander 206, is similar to the VBG beam expander of FIG. 1A, which is formed of a first VBG and a second VBG, as described above.

In some implementations, the phase mask 208 can be a microlens array (MLA) that can encode the spectral response of the beam expander 206, as described above. In one or more implementations, the display panel 210 can be made of LCD or TFT LCD, as described above.

The display 200B is formed of a number of pixels 212, a representation of which pixel 214 shows a shaded region that is used by an electrode and conductors of a circuit on the LCD pixel. This would limit the LCD fill factor. In addition, the LCDs generally have larger areas compared to LCOS display devices.

FIGS. 2C, 2D, 2E and 2F are schematic diagrams illustrating an example of a beam expander 200C with improved throughput along with images 200D, 200E and 200F of corresponding beams, according to certain aspects of the subject technology. The beam expander 200C shows the detail structure of the beam expander 206 of FIG. 2A. The beam expander 200C includes a light source 220, which can be a small (e.g., about 2 mm) laser, a first VBG 222 and a second VBG 224. The first VBG 222 is a VBG layer that diffracts the incoming light from the light source 220 along the length of the VBG layer into the second VBG 224 to form an expanded beam (e.g., a dimension of 2 cm).

FIGS. 2D and 2E show images 200D and 200E of corresponding beams along the first VBG 222 and the second VBG 224, in two dimensions. FIG. 2F shows an image 200F of a three-dimensional view of the expanded beam formed by the second VBG 224. The shape of the three-dimensional view follows the shape of the laser beam formed by the beam shaper 204 of FIG. 2A and is not limited to circular, as shown in FIG. 2F, and can take Gaussian, rectangular or other shapes.

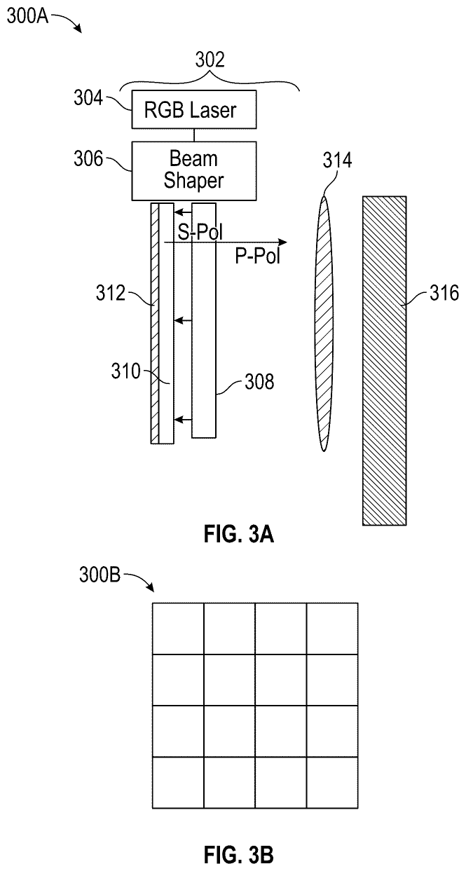

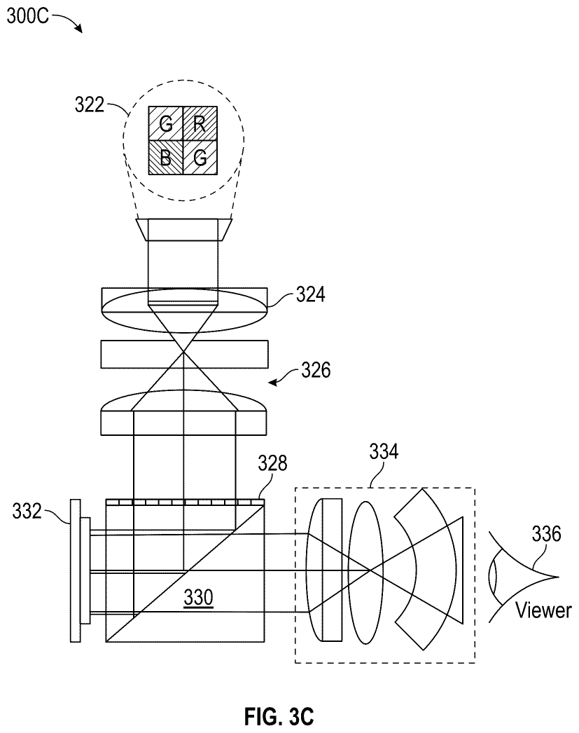

FIGS. 3A and 3B are schematic diagrams illustrating an example of a compact LCOS display system 300A along with a corresponding display 300B with improved fill-factor, according to certain aspects of the subject technology. The compact LCOS display system 300A includes a compact LCOS beam expander 302, a projection lens 314 and a waveguide 316 for an AR display. The compact LCOS beam expander 302 includes a light source 304 (e.g., an RGB laser), a beam shaper 306, and a compact VBG beam expander 308 (hereinafter, beam expander 308), an LCOS 310 and an aluminum (Al) layer 312. The beam shaper 306 can be a collimator that can collimate the input light from the light source 304 and shape it into a beam profile that can be circular or other shapes. The collimated and/or shaped beam from the beam shaper 306 is received by the beam expander 308, which expands the received light beam into the LCOS display device. The Al layer 312 is a reflector and reflects the expanded beam to the projection lens 314 and the waveguide 316, which can be the waveguide of an AR or VR device. The circuits and wirings of the LCOS 310 are embedded behind the Al layer 312.

FIG. 3B show a corresponding display 300B of the compact LCOS display system 300A. As compared to the display 200B of FIG. 2B of an LCOS the fill factor of the compact LCOS display system 300A shows a significant improvement.

FIG. 3C is a schematic diagram illustrating an example of an existing LCOS display system 300C. The LCOS display system 300C includes a light source 322 (e.g., an RGB laser), a condenser lens 324, a lens array 326, a pre-polarizer layer 328, a polarization splitter 330 and an LCOS display device 332. Also shown in FIG. 3C are a projection lens 334 and viewer eye 336. The polarization splitter 330 is a splitter cube, which adds to the volume of the existing LCOS display system 300C. The subject technology, as shown in FIG. 3A, replaces the polarization splitter 330 with the beam expander 308, which improves the compactness of the overall system.

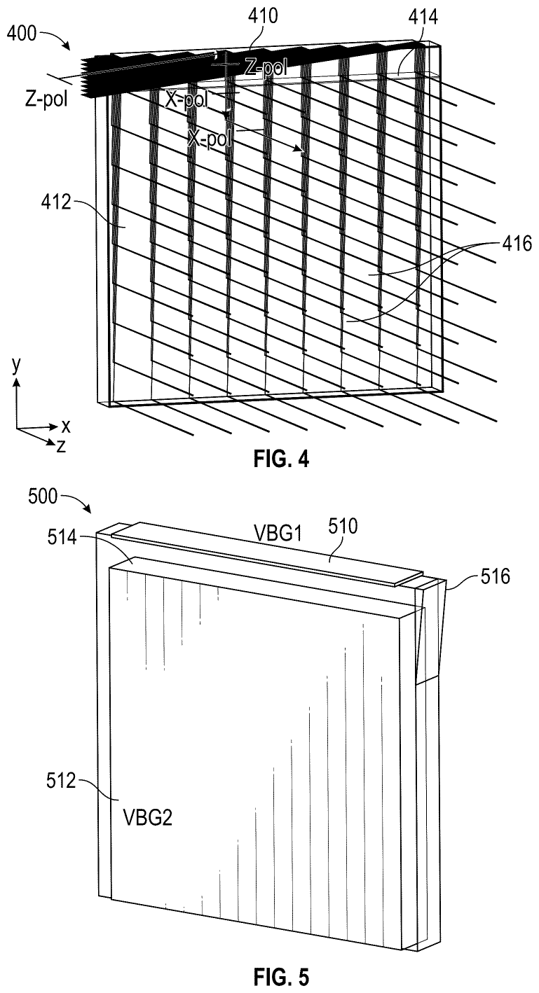

FIG. 4 is a schematic diagram illustrating an example of a monolithic dual VBG illuminator 400 with a waveplate 414, according to certain aspects of the subject technology. The monolithic dual VBG illuminator 400 (hereinafter, VBG illuminator 400) includes a first VBG 410, a second VBG 412 and the waveplate 414. The first VBG 410 and the second VBG 412 are similar to the first VBG 104 and the second VBG 106 of FIG. 1A, respectively, as described above. The waveplate 414 (e.g., a polarization switching layer is a half-wave plate (HWP) embedded between the first VBG 410 and the second VBG 412, transmits the light beam generated by the first VBG 410 and modifies its polarization state without attenuating, deviating, or displacing the beam. The waveplate 414 can switch a first polarization of the light beam to a second polarization. In some implementations, the waveplate 414 converts the Z-polarization of the light beam to an X-polarization that is expanded to a two-dimensional beam depicted by the rays 416. For a Z-polarization the electric field (E) is parallel to the Z axis, while for the X-polarization, the electric field is parallel to the X axis of the XYZ coordinate system shown in FIG. 4 for illustration purposes. Accordingly, a collimated input beam in the XY plane with Z-polarization and having a diameter of about 2 mm is converted into a collimated output beam, with a diameter of about 20 mm, propagating along the Z-direction with X-polarization.

The input collimated beam is diffracted off of the first VBG 410 with maximum efficiency along the Y-direction because the Z-polarization is aligned along the grooves of first VBG 410 (S-polarization). After passing through the waveplate 414, the diffracted beam switches to X-polarization, aligned along the grooves of the second VBG 412 (S-polarization). The light is then diffracted off of the second VBG 412 with a high diffraction efficiency (e.g., >95%) along the Z direction. Accordingly, the VBG illuminator 400, by including the waveplate 414, exploits the maximum diffraction efficiency of the first VBG 410 and the second VBG 412.

It should be noted that a VBG behave as a series of reflectors. When constructive interference occurs at Bragg condition, it result in high diffraction efficiency. This diffraction efficiency is a function of light polarization. Similar to a general reflector, S-polarized reflection diffraction efficiency is higher than P-polarization. Especially at Brewster angle, S-reflection diffraction efficiency can reach to about 100% while P-reflection diffraction may be about 0%. The dual diffraction in a compact illuminator occurs in an orthogonal plane, and therefore the optimal polarization diffracted from the first diffraction is orthogonal to the polarization optimal for the second diffraction. To link the two diffractions with optimal polarization, the waveplate 414 is in the light path between the two diffractions.

FIG. 5 is a schematic diagram illustrating the example monolithic dual VBG illuminator of FIG. 4 with an optional prism, according to certain aspects of the subject technology. The embodiment 500 shown in FIG. 5 includes a first VBG 510, a second VBG 512 and a waveplate 514, which are similar to the first VBG 410, the second VBG 412 and the waveplate 414 of FIG. 4. The first VBG 410 and the second VBG 412 are similar to the first VBG 104 and the second VBG 106 of FIG. 1A, respectively. The embodiment 500 further includes a prism 516 with a wedge face, which is an optical component. The prism 516 is a shallow prism (e.g., with a thickness of about a few microns) placed adjacent to the illumination source (e.g. 304 of FIG. 3A) that can be abutted to a wedged face of the prism 516. This configuration provides a compact coupling between the illumination source and the beam expander that is rugged against misalignment of the different components. In some implementations, the prism 516 can be replaced with a mirror. In some implementations, the first VBG 510 can have dimensions of about 22×2.6 mm, the second VBG 512 can have dimensions of about 22×20 mm. In some implementations, the first VBG 510 and the second VBG 512 are fabricated on a substrate with dimensions of about 22×22×2.6 mm. These exemplary dimensions and the implementation of the embodiment 500 is not limited to these dimensions.

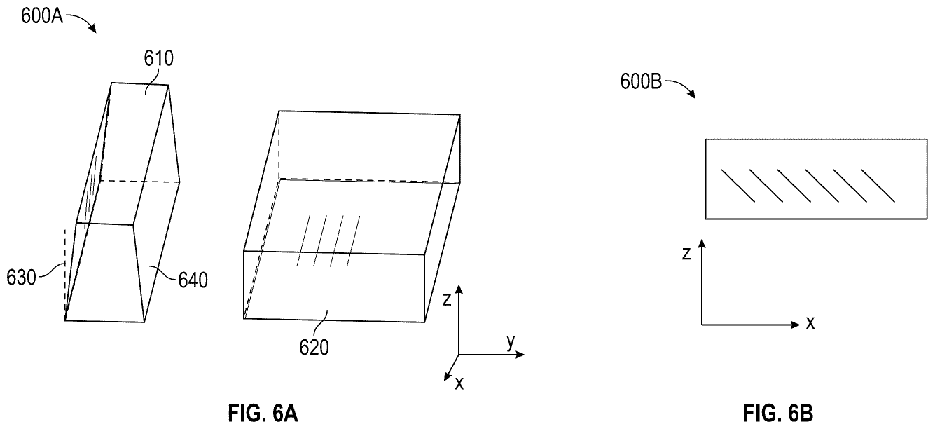

FIGS. 6A and 6B are schematic diagrams illustrating an example of a monolithic dual VBG illuminator 600A with a half-wave film 640 and a cross-sectional view 600B of the half-wave film, according to certain aspects of the subject technology. The monolithic dual VBG illuminator 600A includes a first VBG 610 and a second VBG 620. In one or more implementations, the input surface of the first VBG 610 can have an angle q with respect to the Z axis of the XYZ coordinate shown adjacent to the second VBG 620. In some aspects, the angle q can be optional or can have a small value (e.g., a few degrees).

The bonding between the substrates of the first VBG 610 and the second VBG 620 is optional. This bonding at the half-wave film 640 can reduce the film/air and substrate/air reflection losses. The bonding of the first VBG 610 and the second VBG 620 together can be more manufacture-friendly in terms of alignment for the overall system. As seen from FIG. 6A, the equal index lines in the first VBG 610 can be along the vertical direction (Z-axis), and the equal index lines of the second VBG 620 can be along horizontal direction (X-axis).

The cross-sectional view 600B of the half-wave film shown in FIG. 6B depicts the fast axis of about 45 degrees with respect to the horizontal direction (X-axis). The light polarized along the fast axis travels faster than the light along the slow axis.

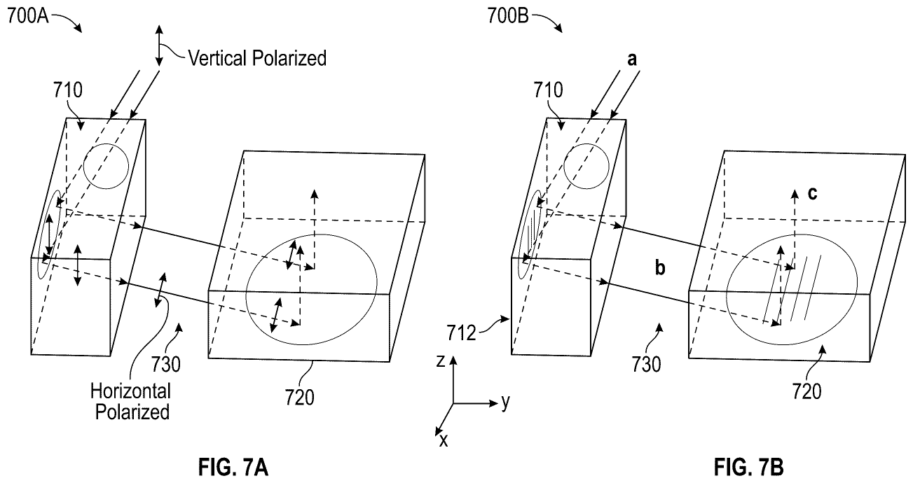

FIG. 7A is a schematic diagram illustrating an example of a monolithic dual VBG illuminator 700A with a polarizing component, according to certain aspects of the subject technology. The monolithic dual VBG illuminator 700A includes the first VBG 710, a second VBG 720 and a polarizing component 730 (e.g., a half-wave plate) placed in space between the first VBG 710 and the second VBG 720. FIG. 7A depicts polarization propagating between first VBG 710 and the second VBG 720. In some implementations, the polarizing component 730 can be a half-wave plate bonded between first VBG 710 and the second VBG 720 or a half-wave film formed on the first VBG 710.

VBGs typically have higher diffraction efficiency on S-polarized (perpendicular to the plane) light. To make both VBGs (first VBG 710 and the second VBG 720) have high diffraction efficiency, a polarization manipulation component such as a polarizing component 730 is placed in between the VBGs to rotate the light polarization to be S-polarized for the plane of the second VBG 720.

FIG. 7B is a schematic diagram illustrating an example of a monolithic dual VBG illuminator 700B with an angled surface first VBG 710, according to certain aspects of the subject technology. The monolithic dual VBG illuminator 700B is similar to the monolithic dual VBG illuminator 700A of FIG. 7A except that the first surface of the first VBG 710 has an angle 712 with respect to the Z axis of the XYZ coordinate system shown in FIG. 7B. In some implementations the angle 712 can be about 5.7 degrees but is not limited to that value and can be smaller or larger than 5.7 degrees. As seen from FIG. 7B, the beam of illumination has a downwards propagation direction.

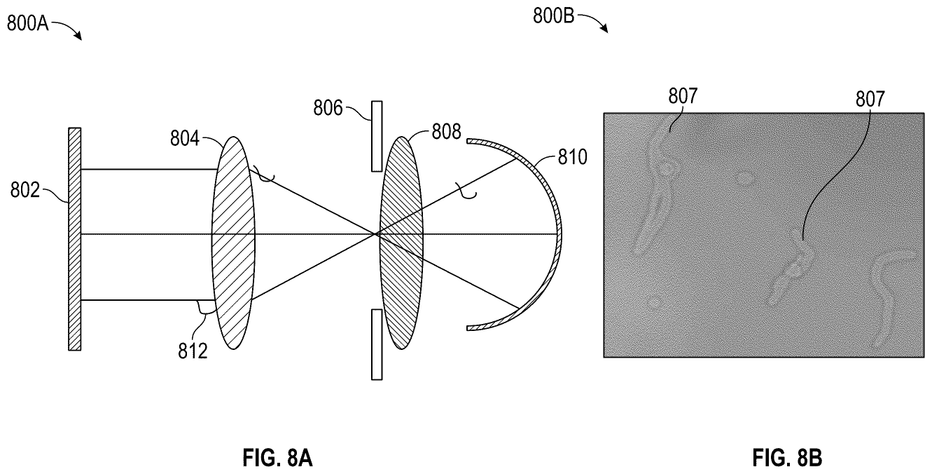

FIGS. 8A and 8B are schematic diagrams illustrating examples of backlight system 800A with a collimated beam and a corresponding image 800B including artifacts. The existing backlight system 800A (e.g., an LCOS) includes a backlight source 802 (illuminator) and an imaging lens 804 that focuses the incoming light from the backlight source 802 through a pupil 806 into a lens 808 of an eye of a viewer, which forms an image on the retina 810 of the viewer.

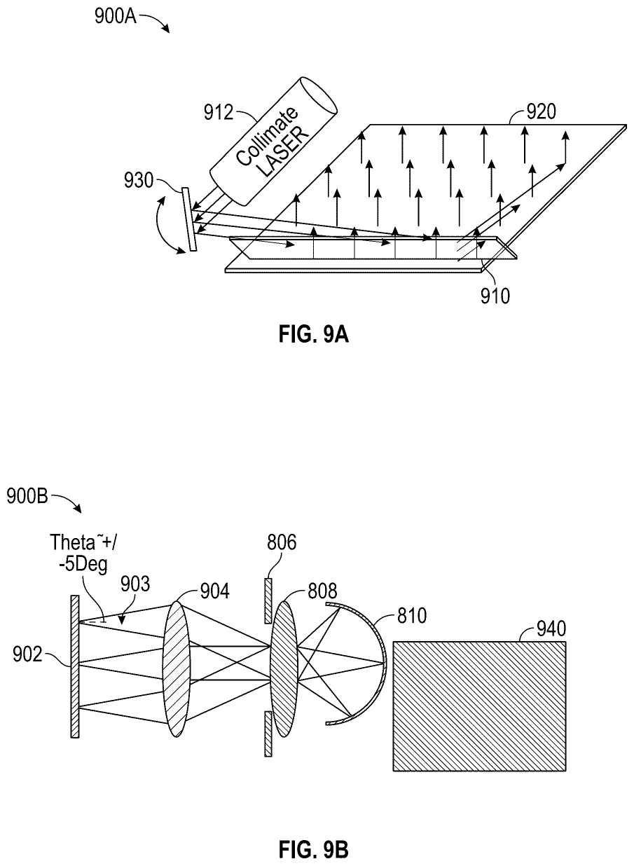

FIG. 8B depicts the image 800B formed on the retina 810. With a collimated beam through the backlight system 800A, artifacts 807, due to the fine narrow beam and pupil 806, are shown to appear in the image. The source of these artifacts can be tiny dusts and/or tiny blockers along the rays of the narrow beam or scratches on the imaging lens 804, which can result in significant image nonuniformities (brightness changes). This artifact can also be observed by the human eye looking at bright uniform sky seen as floaters within the eye. The subject technology mitigates these artifacts, as shown and discussed with respect to FIG. 9B below.

FIGS. 9A and 9B are schematic diagrams illustrating examples of compact beam expander 900A with illumination steering and corresponding a backlight system 900B, according to certain aspects of the subject technology. The compact beam expander 900A (LCD or LCOS, herein after beam expander 900A) includes a collimated light source 912, a first VBG 910, a second VBG 920 and a beam scanner 930. The beam scanner 930 can be a microelectromechanical system (MEMS) reflector that can vary the angle of incidence of the incoming collimated beam on the first VBG 910 of the beam expander 900A. The movable reflector scans a desirable angular spread for the input pupil.

The backlight system 900A of the subject technology is an improved version of the backlight system 800A of FIG. 8A in the sense that the illumination angle (Theta) is greater than zero (e.g., less than or equal to about 5 degrees). Similar to the backlight system 800A, the backlight system 900B includes an Illuminator 902 (LCD or LCOS) with an illumination angle (theta) and an imaging lens 904, which produce a focal area on the lens 808 through the pupil 806 (eye pupil). The illumination angle theta can be controlled by the beam scanner 930 of FIG. 9A. The illumination angle theta for LC illumination would increase the pupil size, as shown in FIG. 900B. The increased pupil size is in fact the result of the focal point being converted to a focal area to avoid artifacts due to issues such as dust or scattering at eye location thus improving uniformity of displayed image. By increasing the input aperture in the imaging lens 904, admitting a wider angle of incident light for each source point in the LCOS display (e.g., a pixel), the incident light in the viewer's retina is smeared out (e.g., blurred) such that the artifacts are washed away.

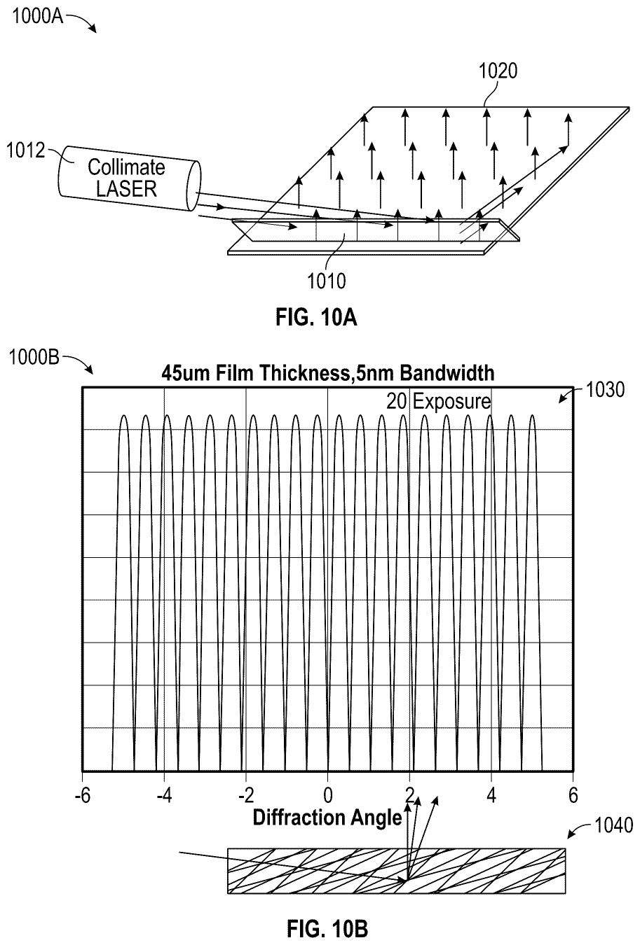

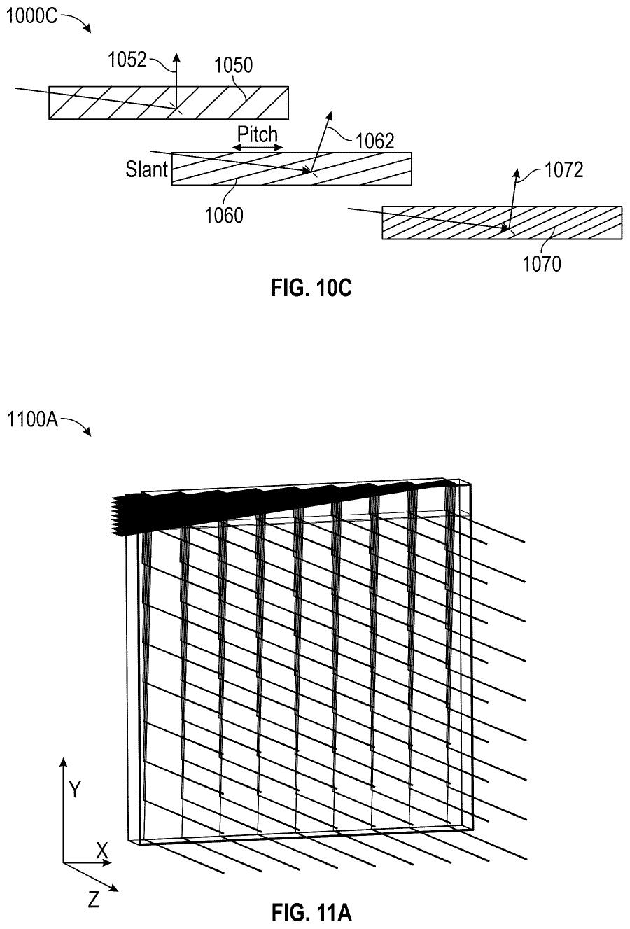

FIGS. 10A and 10B are schematic diagrams illustrating examples of compact beam expander 1000A and a multiplexed (MUX) VBG, according to certain aspects of the subject technology. The compact beam expander 1000A includes a light source 1012 (e.g., a collimated laser), which produce a beam of light directed to a first VBG 1010 that diffracts the beam of light into a second VBG 1020. At least one of the first VBG 1010 and second VBG 1020 include a MUX grating, as shown by the MUX grating 1040 of FIG. 10B. FIG. 10B also shows a diagram 1000B of an exposure pattern including a number of (e.g., 20) sinusoidal exposures via a photo interference technique, which is used to write the grooves of the grating into a substrate.

FIG. 10C is a schematic diagram illustrating examples of steps in forming a MUX pitch VBG, according to certain aspects of the subject technology. By exposing a substrate multiple times with different diffraction angles, various grooves (e.g., 1050, 1060 and 1070) with different pitch values can be produced on the same substrate to form a MUX grating. Each set of grooves can diffract the incident beam of light into different directions (1052, 1062 and 1072) at different angles corresponding to the different pitch values. Each of the steps shown in 1000C produces a set of grooves with a specific pitch. The result of these steps is the MUX grating 1040 of FIG. 10B, which are created on a substrate to produce a MUX pitch VBG.

The compact beam expander 1000A with MUX VBG is another implementation for achieving the desirable angular spread for the input pupil, as performed by the beam scanner 930 of FIG. 9A. In other words, the reason that the compact beam expander 1000A does not use any beam scanner is that the functionality of the beam scanner is replaced with using MUX VBG(s).

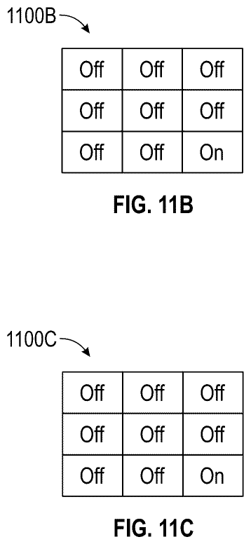

FIGS. 11A, 11B and 11C are schematic diagrams illustrating examples of a compact beam expander 1100A with zonal illumination and corresponding images 1100B and 1100C of a small beam and an expanded beam, respectively, according to certain aspects of the subject technology. The compact beam expander 1100A is similar to the VBG illuminator 400 of FIG. 4 and uses an array (grid) of lasers (e.g., 2×2 mm) instead of a single illuminating light source producing an incident beam of light. The incident beam of light is in the Z direction of the XYZ coordinates shown in FIG. 11A and is diffracted by the compact beam expander 1100A to produce a zonal illumination with larger dimensions (e.g., 20×20 mm). This feature is a power-saving feature that allows turning on only the specific lasers of the array that are needed and keeping the rest of the lasers of the array off to save power. For example, in the 3×3 laser array 1100B that includes 9 lasers, only the ninth laser is on, and the rest of the lasers are off. This illumination results in a 9-zone light beam (in the Z direction), as shown by the image 1100C of FIG. 11C, where only the 9th zone is on, and the rest of the zones are off. In other words, the compact beam expander 1100A allows producing a zonal illumination pattern with selective on and off zones in the field of view. For example, in an AR application, the zonal feature of the subject technology allows forming a zoned display, where portions of the LCOS display may be desirably turned off to allow for direct transmission of light through the eyepieces of a smart glass. Accordingly, a portion (e.g., a corner of at least one of the eyepieces) may be left to display computer-generated images, a readable text or symbol, etc. Moreover, the zone that is turned on in the display may change dynamically, accordingly the AR application. Note that each of the zones may include multiple pixels in the LCOS display, so that a fairly complex image may be displayed (e.g., with a high resolution, contrast, color gamut, etc.).

The compact beam expander 1100A has an additional advantageous feature beyond saving power in that it can improve the image contrast as well, because only the zones of interest receive light.

The compact beam expanders of the subject technology, including the compact beam expander 1100A, can be used in various optical devices such as AR/VR headsets.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially described as such, one or more features from a described combination can in some cases be excised from the combination, and the described combination may be directed to a sub-combination or variation of a sub-combination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples, and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

Aspects of the subject matter described in this disclosure can be implemented to realize one or more of the following potential advantages. The described techniques may be implemented to support a range of benefits and significant advantages of the disclosed eye tracking system. It should be noted that the subject technology enables fabrication of a depth-sensing apparatus that is a fully solid-state device with small size, low power, and low cost.

A significant aspect of the disclosed technology is that it provides a solid state (e.g., silicon) photonic interference system that is capable of depth sensing of the corneal shape to determine a gaze direction.

As used herein, the phrase “at least one of” preceding a series of items, with the terms “and” or “or” to separate any of the items, modifies the list as a whole, rather than each member of the list (i.e., each item).

To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An apparatus, comprising:
a light source configured to generate a light beam;
a first grating illuminated by the light beam; and
a second grating optically coupled to the first grating,
wherein the first grating is configured to perform a first diffraction to expand the light beam in a first dimension to form a first beam, and
the second grating is configured to perform a second diffraction to expand the first beam in a second dimension to provide a backlight for a display device.

2. The apparatus of claim 1, wherein the first grating is illuminated by a collimated light beam of a laser source.

3. The apparatus of claim 1, wherein the first diffraction comprises a first single diffraction configured to expand the light beam in the first dimension of the first grating coupled to the second grating.

4. The apparatus of claim 1, wherein the second diffraction comprises a second single diffraction configured to expand the expanded first beam in the second dimension to form a two-dimensional beam perpendicular to a plane of the second grating.

5. The apparatus of claim 1, wherein the first grating comprises a first volume Bragg grating (VBG), and the second grating comprises a second VBG.

6. The apparatus of claim 5, wherein the first VBG and the second VBG comprise single-diffraction VBGs.

7. The apparatus of claim 5, wherein at least one of the first VBG and the second VBG comprise multiplexed (MUX) VBGs including multiple gratings with different pitches configured to increase a diffracted angle range.

8. The apparatus of claim 1, wherein the display device comprises an augmented reality (AR) or a virtual reality (VR) display.

9. The apparatus of claim 1, wherein the display device comprises a liquid crystal display (LCD) device.

10. The apparatus of claim 1, wherein the display comprises a liquid crystal on silicon (LCOS) display device.

11. The apparatus of claim 1, further comprising a polarizing component between the first grating and the second grating, wherein the polarizing component comprises a half-wave plate configured to change a polarization state of the first beam.

12. The apparatus of claim 1, further comprising a reflector plate configured to steer the light beam at various angles to increase a pupil size of the backlight.

13. The apparatus of claim 1, wherein the light source comprises a grid of lasers, and wherein each laser of the grid is selectively controllable to be switched on or off to convert the backlight to a zonal backlight.

14. A beam expander system, the system comprising:
a laser configured to generate a first beam;
a first Bragg grating illuminated by the first beam;
a polarizing component; and
a second Bragg grating optically coupled to the first Bragg grating,
wherein the first Bragg grating is configured to create a first diffracted beam in a first dimension,
the polarizing component is configured to change a polarization state of the first diffracted beam, and
the second Bragg grating is configured to create a second diffracted beam to expand the first polarized diffracted beam in a second dimension to provide a backlight for a display device.

15. The system of claim 14, wherein the first Bragg grating comprises a first VBG and the second Bragg grating comprise a second VBG.

16. The system of claim 14, wherein the first diffracted beam comprises a first single diffracted beam expanded in the first dimension of the first Brag grating, and wherein the second diffracted beam comprises a second single diffracted beam.

17. The system of claim 14, wherein the first diffracted beam comprises a first MUX diffracted beam expanded in the first dimension of the first Brag grating, and wherein the second diffracted beam comprises a second MUX diffracted beam.

18. A beam expander system, the system comprising:
a first VBG illuminated by a first collimated beam and configured to form a first diffracted beam along a length of the first VBG;
a polarizing component configured to switch polarization state of the first diffracted beam; and
a second VBG configured to expand the first polarized diffracted beam to form a backlight for a display device.

19. The system of claim 18, wherein the first VBG comprises a first MUX VBG, wherein the second VBG comprises a second MUX VBG, and wherein the polarizing component comprises a half-wave plate.

20. The system of claim 19, further comprising a collimated light source to generate the first collimated beam, wherein the collimated light source comprises a grid of lasers, and wherein the grid of lasers is configurable to generate a zonal beam pattern that results in a zonal backlight.
